(19) United States
(12) Patent Application Publication
(10) Pub. No.: US 2017/0181378 A1
(43) Pub. Date: Jun. 29, 2017

(54) Improved Accumulator Circuit for Towed Implements

(71) Applicant: OWEN J. BROWN, JR., PITTSFIELD, IL (US)

(72) Inventor: OWEN J. BROWN, JR., PITTSFIELD, IL (US)

(21) Appl. No.: 15/118,485

(22) PCT Filed: Feb. 13, 2015
(86) PCT No.: PCT/US15/15798

§ 371 Date: Aug. 12, 2016

Related U.S. Application Data
(60) Provisional application No. 61/939,115, filed on Feb. 12, 2014.

(51) Int. Cl. A01F 15/08; F15B 11/08; B66F 9/22; F15B 13/04; F15B 13/042; F15B 1/04; F15B 13/02

(52) U.S. Cl. CPC A01F 15/0841; F15B 1/04; F15B 11/08; F15B 13/027; F15B 13/0401; F15B 13/042; B66F 9/22; F15B 2211/20538; F15B 2211/20546; B60P 3/00

(57) ABSTRACT

An apparatus and a system directed to an improved hydraulic circuit for use on implements powered by separate motorized vehicle such as a tractor. The apparatus and system include an implement, such as a bale processing or stacking device, configured with wheels to be a towed vehicle, with the towed vehicle configured to be conveyed by a tow vehicle. Additionally, a hydraulic pump on the tow vehicle is coupled to one or more accumulators on the towed device to provide hydraulic power at varying rates as needed by one or more mechanical operations of the implement vehicle. A hydraulic circuit including check and block valves in concert with a pressure switch on the implement device obtains hydraulic power from the tow vehicle from a hydraulic pump located on the tow vehicle via one or more hydraulic transfer lines from the tow vehicle to the implement.

### CROSS REFERENCE TO RELATED APPLICATIONS

This non-provisional patent application claims priority benefit, with regard to all common subject matter, of earlier filed U.S. Provisional Patent Application Ser. No. 61/939,115, filed 12 Feb. 2014 (12/02/2014), and entitled “ACCUMULATOR CIRCUIT FOR TOWED IMPLEMENT”. The identified earlier-filed provisional patent application is hereby incorporated by reference in its entirety into the present non-provisional application.

### STATEMENT REGARDING FEDERALLY FUNDED RESEARCH

Not applicable

### TECHNICAL FIELD OF INVENTION

The present invention is directed to an improved hydraulic accumulator system for a towed implement device to be powered by a hydraulic pump located on a tow vehicle In more detail, the present invention relates to an implement such as a bale processing or stacking device, such as a baler or bale stacker for bales of straw, alfalfa, and/or hay used in the hay and livestock farming industry, which is towed by a tow vehicle and which is further adapted for being powered by the tow vehicle. Further embodiments relate to other implements requiring power to operate, such as a raker, baler, a hale pickup conveyor, or the like, to be powered through the use of this hydraulic circuit invention.

### BACKGROUND ART OF THE INVENTION

Modern farming practice typically involves a multitude of equipment for preparing fields, cutting or mowing of the crop, and pickup, baling, stacking and/or transfer of the harvest to storage and eventual use or sale, said equipment known generally as implements, which are conveyed by a motorized vehicle, typically a tractor or other large-wheeled powered vehicle suitable for use in soft field conditions. Many of these implements rely on power provided by the motorized vehicle in the form of direct mechanical coupling, such as a power-takeoff driveshaft, connective means to derive power via a transfer of compressed air from a compressor or of pressurized hydraulic fluid from one or more hydraulic pumps on the motorized vehicle or by transfer of electrical power. The amount of power provided by the motorized vehicle must match the amount and timing of the demand of the implement, for efficient and safe operation of the implement.

### PRIOR ART AND TECHNICAL PROBLEMS TO BE SOLVED

In the specific application of transfer of a pressure means, such as compressed air or hydraulic fluid, from a motorized towing or pushing vehicle to one or more implements, the implements are typically designed to only work with a limited range of capacities of compressors or hydraulic pumps provided as standard equipment by manufacturers of the motorized vehicles, and as a result may not typically work reliably with many smaller or less expensive tow vehicles. For example, various styles of bale processing and stacking device systems for creating, stacking and/or strapping a plurality of smaller bales of fibrous material such as hay into larger strapped arrays of bales for efficient handling, storage and shipping have been known and used, such as the Bale Stacking Apparatus device claimed in U.S. Pat. No. 6,655,266 by the inventors of the subject invention. However, all styles of bale processing and stacking device systems are designed to be powered by a known range of power sources, typically a limited range of hydraulic pumps mounted on a limited range of tow vehicles configured to maintain sufficient hydraulic pressure and flow rate for the combination of mechanical devices on said bale processing or stacking devices. The subject invention addresses this limitation through the novel combination of one or more hydraulic accumulators with one or more check valves, block valves and pressure switches with feedback and control means all arranged into a circuit.

Accumulators are a common off the shelf component used in many industrial and mobile applications mounted on the motorized vehicle hard piped into the hydraulic system of the vehicle. These are typically connected in closed systems where all components including the capacities and flow rates of the hydraulic power source (pump) are known and selected or designed to meet the specific parameters of the entire mechanical system.

What has not been anticipated by prior art in practice is for the accumulator, in concert with one or more check valves, block valves and pressure switches, to be located on and plumbed into the hydraulic circuit of an implement, outside the battery limits of the motorized drive unit such as a tractor, and furthermore allowing an essentially unlimited range of hydraulic pumps and tractors to safely provide variable degrees of hydraulic power without excessive damaging heat buildup. Typically in prior art, the implement is designed for using a known tractor's pump capacity, including any accumulator which may be mounted on the tractor.

One prior art citation was located where the accumulator is in the same circuit and towed vehicle as the implement mechanical devices, U.S. Patent Application 20130313351, entitled “Apparatus and System for a Towed Device Powered by a Tow Vehicle”, which embodiments include using a hydraulic pump mounted on a truck to power a wood chipper cutting blade, said wood chipper mounted on a trailer towed by the truck. The application lists both the use of fixed displacement as well as variable replacement pumps.

The above prior art does not address nor solve the problems associated with a fixed displacement pump that are outlined and solved by the subject invention. Since the inventor of above said prior art circuit, while skilled in the applicable art, did not anticipate the unexpected benefits resulting from inclusion of key components of subject invention's circuit including but not limited to (1) blocking valve, (2), check valve and (3) pressure switch, said prior art suffers the same problems that are associated with a fixed displacement pumps as described herein.

For example, when instantaneous hydraulic load is less than a fixed displacement pump output, the excess oil that is pumped will be dumped to the system's storage tank over the pump's relief valve at the pressure required to function the load. This “bleed over” can create excessive heat and can damage the pump. In order for prior art's accumulator(s) to fill back up, then the fixed displacement pump's output must be greater than the minimum hydraulic load. As with most prior art applications, the hydraulic load of the chipper is going to be variable and as unpredictable as the operator input. Therefore timing the chipper hydraulic load (for example adding tree limbs) with the accumulator fill level is practically impossible. Because of this there are resultant periods of time where the accumulator(s) are full and the hydraulic load is at its minimum. When this occurs the fixed displacement pump will be providing excess oil which will dump to the reservoir tank and create deleterious heat. Prior art has nothing to protect their system from this large swing in pressures and flows when using fixed displacement pumps, beyond adding additional and expensive heat removal oil coolers.

The above prior art has no pressure switch to detect when the accumulators are full. Prior art has no blocking valve to open up and to allow the fixed displacement pump's excess oil to free flow return to the reservoir with zero psi pressure drop. Prior art has no strategically located check valve that holds the pressure to the accumulators while the excess pump oil is being circulated to the reservoir.

### SUMMARY OF THE INVENTION

It is an object of the present invention to overcome the disadvantages of the prior art by providing an improved compressive media circuit means particularly suited for towed vehicles and implements.

Embodiments of the present invention include an apparatus and a system for powering an implement, such as for example a bale stacking device, with a tow vehicle. Exemplary embodiments include a bale stacking device configured to be a towed vehicle, with the towed vehicle configured to be towed behind the tow vehicle. However, other embodiments within the scope of this invention include the implement configured to pushed or otherwise conveyed beside or in front of the tow vehicle or tractor.

In preferred embodiments, the tow vehicle and the towed implement vehicle are configured to operate on a field or unpaved road at a linear travel speed within a range of zero to approximately twenty miles per hour. Embodiments additionally include one or more accumulator, check valve and block valves coupled to the implement or bale stacking device and operable to provide variable power to the implement or bale stacking device mechanical components; and one or more hydraulic fluid transfer lines connecting the implement hydraulic circuit with the tow vehicle pump and operable to communicate the device-operating power from the pump to the implement pressure-driven mechanical components.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Embodiments of the present invention are described in detail below with reference to the attached drawing figures, wherein:

FIG. 1 is a schematic depiction of a Hydraulic circuit of invention connected between towed implement and the tow vehicle with fixed displacement pump.

FIG. 2 is a summary chart of experimental data showing variable implement load per unit time.

FIG. 3 is a summary chart of experimental data showing volume change in accumulator(s) when under variable implement load per unit time.

FIG. 4—is a schematic diagram of a hydraulic circuit of invention connected between towed implement and the tow vehicle with variable displacement pump, for powering a bale stacking device from a power takeoff affixed to a tow vehicle according to embodiments of the present invention.

FIG. 5—is an isometric view of an exemplary towed bale stacking implement showing location of accumulator(s) and hydraulic manifold circuit.

FIG. 6-15 are summary graphs comparing reduction to practice test performance results of the subject invention on a Bale Band-It bale stacking implement, at various points in the bale processing and stacking operations of the implement.

FIG. 6—is a graph comparing performance results on different pump setups—Vertical Swing Cylinder—Retract

FIG. 7—is a graph comparing performance results on different pump setups—Vertical Plunger Cylinder—Extended

FIG. 8—is a graph comparing performance results on different pump setups—Vertical Plunger Cylinder—Retracted

FIG. 9—is a graph comparing performance results on different pump setups—Horizontal Plunger Cylinder —Extended

FIG. 10—is a graph comparing performance results on different pump setups—Horizontal Plunger Cylinder—Retracted

FIG. 11—is a graph comparing performance results on different pump setups—Horizontal Plunger Cylinder—Extended Tie Cycle

FIG. 12—is a graph comparing performance results on different pump setups—Strap Guide Motor Up

FIG. 13—Is a graph comparing performance results on different pump setups—Vertical Elevator

FIG. 14—is a graph comparing performance results on different pump setups—Fetcher Cylinders Extended

FIG. 15 is a graph comparing performance results on different pump setups—Fetcher Cylinders Retracted

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. However, other embodiments can be utilized and changes can be made without departing from the scope of the present invention. The following detailed description is, therefore, not to be considered in a limiting sense. The scope of the present invention is defined only by the listed claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

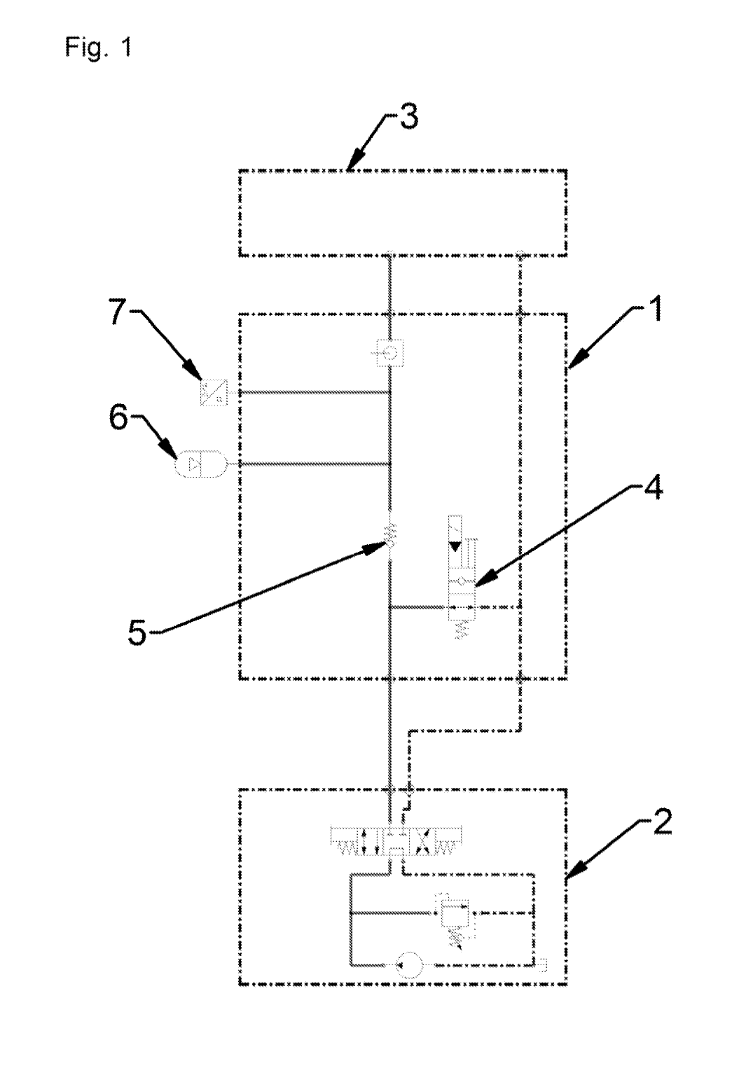

With reference to the drawings, an improved implement hydraulic circuit system 1 with power obtained from a separate motorized vehicle 2 is illustrated in FIG. 1. The improved implement device system 1 broadly comprises implement load circuit 3 configured to be mounted on or integral with an implement vehicle, with the implement vehicle configured to be towed behind, pulled beside or pushed in front of the motorized vehicle.

Further, the implement hydraulic circuit includes a hydraulic accumulator 6, check valve, block valve and pressure switch means for storing energy and providing the stored energy to the applicable mechanisms of the implement device or other associated components at the required pressures and flow rates.

The subject invention operates as follows. In situations where implement load 3 requires continuous flow and a variable flow rate, said invention would allow fixed displacement pump 2 to pump at full capacity operating the load 3 and any excess amount over the load 3 would be used to charge the accumulator(s) 6 and system until upper pressure setting is reached on pressure switch (7), then pressure switch 7 would turn off blocking valve 4 allowing pump 2 to circulate back to tank line at ambient pressure. The check valve 5 holds the pressure to the load 3 and the accumulator(s) 6 continue to discharge and operate load 3 at proper pressure. When pressure in load circuit 3 drops to lower specified amount, then pressure switch 7 turns blocking valve 4 on, allowing pump 2 to run the load 3 and charge the accumulator(s) 6 again. Circuit 1 continues to cycle like this throughout all the varying mechanical actions of the bale stacking device and any other implement being driven by the hydraulic power supplied by the motorized vehicle pump.

Typically the hardest and most extreme situation that can be placed on a fixed displacement pump is running continuous flow with the now rate at zero gpm. This is also known as deadheading the pump. Heat is maximized because 100% attic pump flow at max psi is being dumped to tank. No work is being performed and this converts the high pressure energy to heat. The subject invention prevents this from happening. If the implement load 3 requires no flow then the accumulator(s) 6 will quickly charge and meet the upper pressure setting, then pressure switch 7 turns off the blocking valve 4 and dumps the pump flow to tank at ambient or low pressure and creating little or no waste heat. This meets the requirements of both the implement load 3 and the pump 2. Flow is always available to the implement 3 by the accumulator(s) 6. Therefore even with variable flow requirements the implement 3 will have sufficient flow for proper operation. Fixed displacement pump 2 does not develop heat because either 100% of the flow is being utilized for work, or 100% of flow is being returned back to tank at ambient or low pressure. The hydraulic oil stays in a safe working temperature range. If a different tractor 2 with different flow rate pump is used, then the invention circuit 1 adjusts automatically and works the same way.

Embodiments of the present invention provide for the powering of an implement device including but not limited to a bale stacking device. In particular, although a bale stacking device 17 is described herein as the exemplary towed device, embodiments of the present invention additionally include powering other hydraulically powered systems or devices from motorized vehicle. Such other systems or devices may include, for instance, a baler, a fork lift, front end loader, fertilizer spreader or the like. Therefore, the description herein of the exemplary bale stacking device should not be considered as limiting.

As used herein, the bale stacking device 17 may broadly include any type of machine or device that combines smaller bundles or bales of fibrous materials (e.g., grass, hay, straw, alfalfa, corn silage, cotton, etc.) into larger contained agglomerations. The bale stacking device 17 generally includes an inlet chute or conveyor 18 for receiving, bales into the bale stacking device; one or more positioning mechanisms, such as a positioning ram, a lifter arm, and/or a compressive ram known in the art, which operates at various times in a production cycle to combine the received bales into larger preferably strapped agglomerations of bales; and a discharge gate and ejector ram for ejecting the larger bale agglomerations from the bale stacking device. In certain other embodiments, the bale stacking device 17 may include additional associated components such as bale pickup and feed conveyors for assisting the bales up from the field and into the bale stacking device and lift or ejector cylinders for raising or lowering the feed rollers and/or bale combinations as the bales are being combined into a larger array. In particular, the ejector cylinders may provide assistance for clearing any received but twine-busted bales that is clogging any step of the mechanism.

The various tractor manufacturers make many models of tractors that have a wide variety of hydraulic capabilities. These hydraulic power capabilities vary in both flow rate and pump type. A given hydraulically powered towed implement typically works well with only a segment of these hydraulic power capabilities. If hydraulic power capabilities of the towed implement are not met, they can malfunction in operation, create excessive heat, and/or result in slow or stalled machine operation. Therefore any towed or pushed implement which receives hydraulic power supply from the powered vehicle, or tractor, will only operate with a limited number of tractors. Often this requires operators to purchase a properly rated tractor or external auxiliary power system to meet the hydraulic requirements of the towed implement, greatly increasing cost and inconvenience.

The said invention significantly increases the assortment of external hydraulic power sources that can be used for hydraulically powered towed implements requiring varying degrees of flow or pressure, such as encountered in bale processing and stacking devices. This greatly reduces complexity and capital equipment cost and is much more convenient to utilize tractors already available or smaller less expensive tractors that otherwise would not meet all the hydraulic specifications of the said devices. Of the varying hydraulic power capabilities mentioned, pump type is one of the significant factors that subject invention helps with. There are two basic pump types: fixed displacement pumps and variable displacement pumps. Variable displacement pumps are much more versatile and work well on a wide range of equipment; however, they are not as numerous and are more expensive to purchase and maintain than fixed displacement pumps.

Subject invention takes the functional disadvantages of the fixed displacement pumps and enables said pumps to work as effectively as a variable displacement pump. The design of the fixed displacement pump is that it pumps a fixed amount of oil. This does not work well for implements that require continuous flow at high pressure. For example, if a tractor pump outputs sixteen gpm and the implements require a constant six gpm, then ten gpm is being dumped to tank over the pump's relief valve at the pressure required to function the load. This can create a lot of heat and damage the pump. Secondly, if the implement requires a continuous flow but the flow rate required is variable, then this also causes heat problems for the fixed displacement pump. It works fine for the point in time when the variable rate matches the fixed displacement pump's flow rate, but as soon as the variable rate drops below the pump's fixed displacement rate then oil is bypassed to tank at load pressure, creating heat. The amount of heat created and whether or not this will cause additional problems will be dependent upon flow rate differential, pressure drop across relief valve, hydraulic oil capacity, hydraulic cooling capacity, duration of use, etc. Said invention resolves both of these problems.

In addition to the aforementioned example and situation it has also been found that lower flow tractors do not work well with some variable rate implements that have high peak flow rate requirements, such as encountered in operation of bale processing and stacking devices. The solution by those skilled in the art up until now has been to utilize a higher flow rate variable displacement pump, either on a tractor or power-take-off driveshaft powered auxiliary pump or by adding another engine, either electric or internal combustion, to power the pump. All these options are considerably higher in cost, complexity and inconvenience for the operator. The subject invention allows the actual tractor hydraulic flow to be as low as the implements average required flow. For example an implement that typically requires a variable rate pump and has a recommended flow rate of more than twenty-five gpm, with said invention now can operate the implement at the same hydraulic capacity with a fifteen gpm fixed displacement pump. This not only reduces operator cost but also allows hydraulically smaller and less expensive tractors to sufficiently convey and support big hydraulic-demand towed implement functions such as those encountered by bale processing and stacking devices.

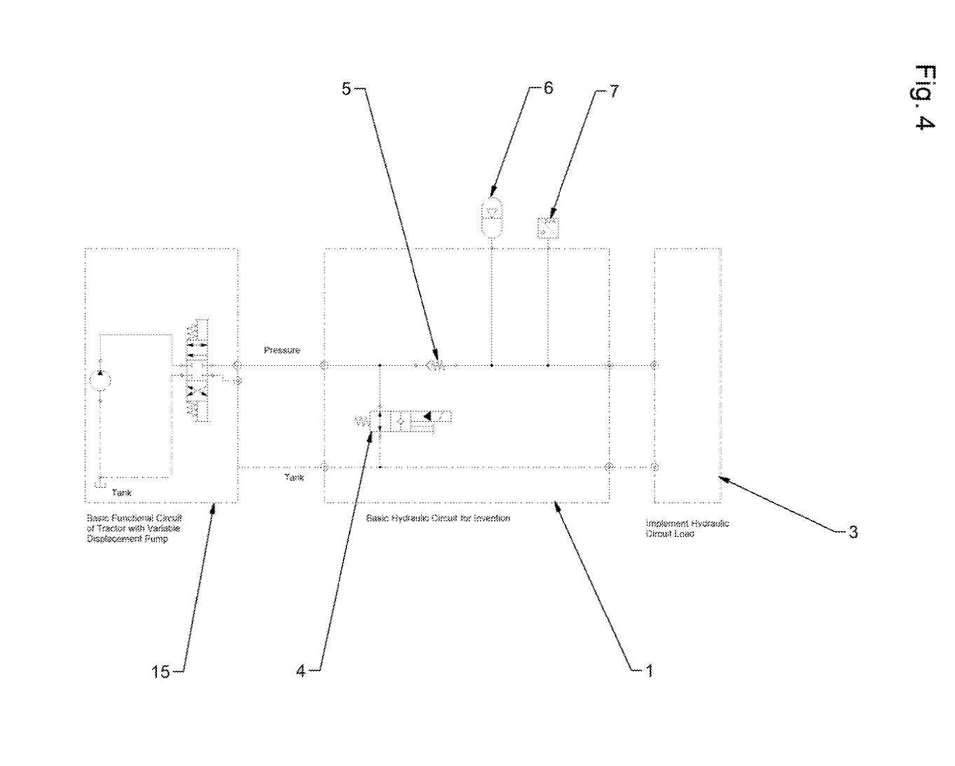

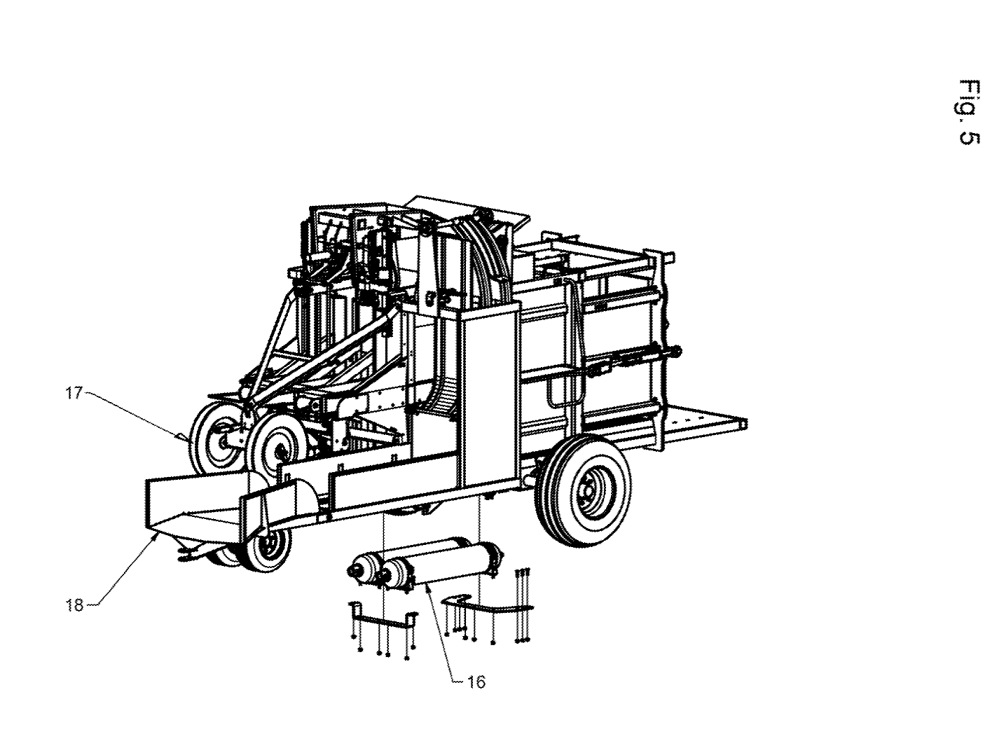

Also subject invention allows low flow rate variable displacement pumps to properly and safely operate variable rate implements that have high peak flow rate requirements. The hydraulic circuit for invention 1 connects between the towed implement's hydraulic load circuit 3 and the tow vehicle's hydraulic pump 2 or 15 as shown in FIG. 1 or FIG. 4 respectively. In one preferred embodiment components such as the blocking valve 4, check valve 5, accumulator(s) 6, and pressure switch 7 are mounted directly to an accumulator manifold 17 to minimize hose and fitting connections. Other embodiments such as shown in FIG. 5 where the accumulator array(s) 16 or other components may be mounted separately from accumulator manifold 17 remain in the scope of subject invention. The exemplary implement application shown in FIG. 5 shows the hydraulic circuit 1 for invention mounted on the towed implement 18. However, for other embodiments and applications it may be advantageous to mount the hydraulic circuit 1 for invention on another towed implement ahead or behind another implement or on the motorized vehicle.

Operation: Notice in first example where implement load 3 requires continuous flow and a continuous flow rate which is below the pump 2 rate. Said invention allows fixed displacement pump 2 to operate load 3 at six gpm and the remaining ten gpm would charge accumulator(s) 6 and system until upper pressure setting is reached on pressure switch 7, then pressure switch 7 would turn off blocking valve 4 allowing pump 2 to circulate back to tank line at ambient pressure. The check valve 5 holds the pressure so that the accumulator(s) 6 continue to discharge and operate continuous six gpm to the load 3 at proper pressure. When pressure in load circuit 3 drops to a lower specified amount, then pressure switch 7 turns blocking valve 4 on, allowing pump 2 to run the load 3 and charge the accumulator(s) 6 again. Circuit 1 continues to cycle in this manner as the towed implement cycles through its various mechanical actions. This meets the requirements of both the implement load 3 and the pump 2. The implement 3 is supplied continuous flow for proper operation. The fixed displacement pump 2 does not develop heat because either 100% of the flow is being utilized for work, or 100% of flow is being returned back to tank at no pressure. This results in the hydraulic oil temperature remaining in a safe working range. If a different tractor with different flow rate is used, then circuit 1 adjusts automatically and works the same way,

Notice in second situation where implement load 3 requires continuous flow and a variable flow rate. Said invention would allow fixed displacement pump 2 to pump at full capacity operating the load 3 and any excess amount over the load 3 would be used to charge the accumulator(s) 6 and system until upper pressure setting is reached on pressure switch 7, then it would turn off blocking valve 4 allowing pump 2 to circulate back to tank line at essentially ambient pressure. The check valve 5 holds the pressure to the load 3 requirements and the accumulator(s) 6 continue to discharge and operate load 3 at proper pressure. When pressure in load circuit 3 drops to lower specified amount, then pressure switch 7 turns blocking valve 4 on, allowing pump 2 to run the load 3 and charge the accumulator(s) 6 again. Circuit 1 continues to cycle like this. Heat is minimized because 100% of the pump flow at low psi is being dumped to tank when not required by load 3.

To avoid the dangerous and undesirable condition of overheating the hydraulic media in the prior art, the subject invention enables a fixed displacement pump 2 to pump at full capacity operating the load 3 and any excess amount over the load would be used to charge the accumulator(s) 6 and system until the upper pressure setting is reached on pressure switch 7, then pressure switch 7 would turn off blocking valve 4 allowing pump 2 to circulate back to tank line at no pressure. The check valve 5 holds the pressure to the load 3 and the accumulator(s) 6. The system is then frilly charged and ready to provide for any and all hydraulic needs of the implement.

When implement 3 begins to function and operate, the accumulator(s) 6 provide the needed flow and begin discharging. When pressure in load circuit 3 drops to the lower specified amount, then pressure switch 7 turns blocking valve 4 on, supplying the implement load 3 with both the pump 2 flow and the accumulator(s) 6 flow added together. This provides the needed higher flow rates. When the required flow rate of the load 3 decreases below the pump 2 flow rate, then the accumulator(s) (6) utilize the extra flow and begin to charge back up. When the flow rate of the load (3) is higher than the flow rate of the pump (2), then the accumulator(s) (6) make up the difference and discharge only what is needed.

The system (1) continuously works in this manner by primarily using the tractor (2) flow for the main volume of oil required but then using the accumulator(s) (6) to supply oil during peak flow requirements and then recovering and filling the accumulator(s) (6) during lower flow times. Therefore tractor (2) flow must be high enough to meet or exceed the average required implement (3) flow over a specified cycle time of the load working at a desired output.

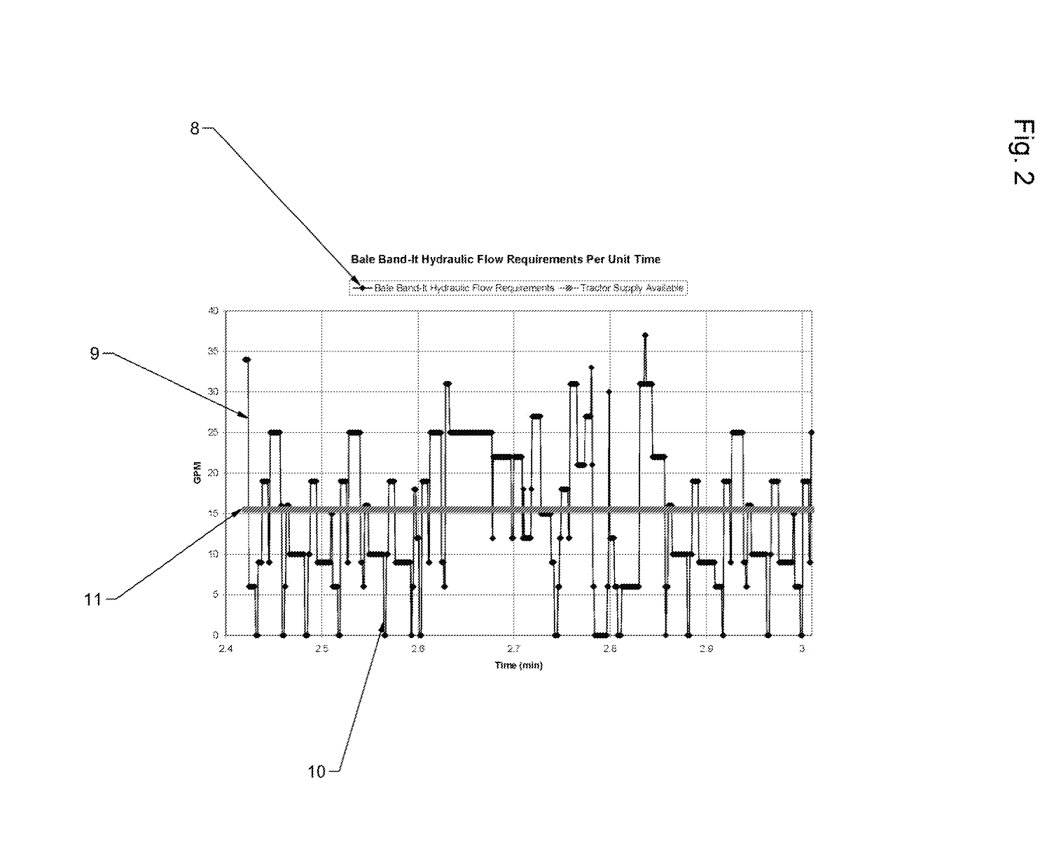

FIG. 2 visually represents this situation. The variable implement load 8 varies significantly depending upon the point in time of the cycle. There are times when there is a high implement load 9. There are times when there is a low implement load 10. From the data of variable implement load 8 the load characteristics of the implement can be determined. One such load characteristic is the average load of the implement. It has been determined for the implement in FIG. 2 that the average load of the implement is approximately fifteen gpm. The pump flow on the tow vehicle 2 must meet or exceed the implement's average load. This is graphically represented by the tractor supply available 11. The pump flow 11 not normally utilized during low implement load 10 is used to charge the accumulator(s) 6. During high implement load 9 the tractor supply 11 is combined with oil from the accumulator(s) 6 to meet the higher implement load 9 requirements.

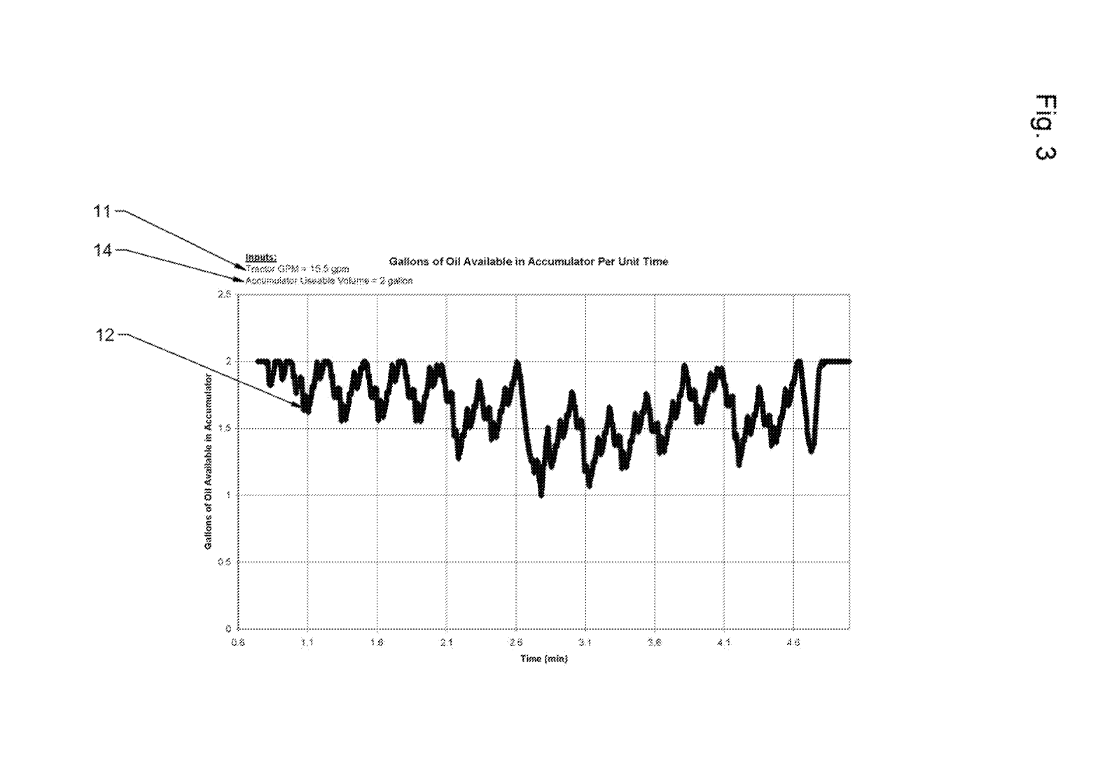

A second such load characteristic is the actual gallons used per length of time. Actual gallons of oil needed per length of time can be calculated by finding the area under the implement load curve 8 for small time intervals throughout the entire load cycle. Comparing the actual gallons used per length of time with the gallons available from the pump 11 per length of time provides the differential volume 12 that the accumulator(s) 6 must account for. This differential volume 12 is graphed in FIG. 3 as the gallons of oil available in accumulator per unit time. When the volume of oil in the accumulator is reduced, then the implement load 8 is higher than the pump flow 11 and therefore the accumulator discharges to make up the difference. When the volume of oil in the accumulator increases, then the implement load 8 is lower than the pump flow 11 and therefore the accumulator charges back up. The pump flow 11 meets or exceeds the implement's average load because the volume in the accumulator 12 always recovers.

For the implement in FIG. 3 the accumulatort(s) 6 were sized to have a two gallon useable volume 14. FIG. 3 shows the volume in the accumulator 12 to have a maximum drop of approximately one gallon. With the accumulator useable volume 14 at two gallons, implement load requirements 8 will be fully met without interruption.

Depending upon the variability of the implement load this invention can significantly reduce the hydraulic flow requirements from the power source 2. If accumulator(s) 6 are sized properly with the implement load 3, the implement can operate at maximum output continuously. Then, when implement hydraulic requirements are reduced, the fixed displacement pump 2 output will fully fill the accumulator(s) 6 and system until upper pressure setting is reached on pressure switch 7, then pressure switch 7 would turn off blocking valve 4 allowing pump 2 to circulate back to tank line at ambient pressure. This meets the requirements of both the implement load 3 and the pump 2. Flow is always available to the implement 3 by the accumulator(s) 6. Fixed displacement pump 2 does not develop heat because either 100% of the flow is being utilized for work, or 100% of flow is being returned back to tank at ambient pressure. Oil stays in safe working temperature range. If a different tractor with different flow rate is used, then circuit 1 adjusts automatically and works the same way.

Note that each implement utilizing this invention would each typically have a different load characteristic. Specifics on accumulator quantity, accumulator size, upper pressure setting, lower pressure setting, etc. may optimally be set different for each implement, but would such customization is not required. The functional concepts of said invention would be identical, but the parameters could be adjusted for each application. While each implement has different load characteristics, the subject invention does not remove those load characteristics but provides a dynamic framework so that each implement can automatically adjust to a much wider range of varying hydraulic power sources.

Another benefit of the subject invention is that it allows low flow rate variable displacement pumps to properly operate variable rate implements that have high peak flow rate requirements. Said invention functions the same as it does with the low flow rate fixed displacement pump, with the following exception. First the blocking valve 4 is placed in the blocked position so that supply oil will not be dumped directly to tank. This can be done by many different methods such as but not limited to using, the manual shift feature of the valve and locking the valve in the blocked position. Pressure switch 7 and blocking valve 4 are therefore not utilized. This is because the variable flow rate pump will automatically compensate for low flow rate load requirements 10. The accumulator(s) 6 work with the supply flow as before. The implement load 3 is supplied with both the pump flow and the accumulator flow added together. This provides the needed higher flow rates. When the required flow rate of the load 3 decreases below the pump flow rate, then the accumulator(s) 6 utilize the extra flow and begin to charge back up. When the flow rate of the load 3 is higher than the flow rate of the pump, then the accumulator(s) 6 make up the difference and discharge only what is needed. The system continuously works in this manner by primarily using the tractor flow for the main volume of oil required but then using the accumulatort(s) 6 to supply oil during peak flow requirements and then recovering and filling the accumulator(s) 6 during lower flow times. Therefore tractor flow must be high enough to meet or exceed the average required flow over a specified cycle time of the load working at a desired output.

Depending upon the variability of the implement load 8 this invention can significantly reduce the hydraulic flow requirements from the power source. If sized properly the implement can operate at maximum output continuously. Then, when the implement's hydraulic requirements 3 are reduced, the variable displacement pump output will fill the accumulator(s) 6 and when the pump's pressure setting is reached, the variable displacement pump will reduce its flow automatically. This meets the requirements of both the implement load 3 and the pump. Flow is always available to the implement by the accumulator(s) 6. Oil stays in a safe working temperature range. If a different tractor with different flow rate is used then the invention circuit 1 adjusts automatically. If a fixed displacement pump 2 is used then the blocking valve 4 should be removed from the locked position.

The following provides steps for a preferred embodiment a specific application of operating the accumulator and accumulator circuit on a sample towed implement, a bale stacking device 18 known commercially and called herein a Bale Band-It.

The accumulator(s) and accumulator circuit are installed on the towed Bale Band-It. The Bale Band-It will connect with tractor or baler via a flexible means. The Bale Band-It can be towed directly behind the tractor in pickup unit mode or towed behind baler. In either mode, the Bale Band-It uses the same hydraulic pressure and return hose connections whether the Bale Band-It has the accumulator option or not.

On initial setup it important to set the pressure detent setting on the tractor. Those skilled in the art will preferably contact their tractor dealer for specifics on how to set the detent for their specific tractor. In the preferred embodiment users of the subject invention should set maximum pressure at 2,950 psi.

Operator must note if the tractor being used has an open center (gear pump) hydraulic system or a closed center (variable displacement pump) hydraulic system. If operator has a closed center (variable displacement pump) hydraulic system then operator must manually lock circulating valve in the closed position using the override function on the valve. If operator has an open center (gear pump) hydraulic system, then override function should be unlocked so that valve can be switched on and off automatically by pressure switch 7.

The accumulators will be filled the first time the operator's tractor applies hydraulics to the system. The accumulators take approximately eight gallons of hydraulic oil. The tractor's hydraulic level will need to be adjusted accordingly. When ready to fill the accumulators operators should pull out on the machine E-Stop button but leave the manual ball valve on the accumulator manifold turned to “Cycle Stop”. Apply hydraulics at tractor and monitor the Pressure Switch. When pressure stops climbing and evens out then press E-Stop button and shut down tractor. Add hydraulic fluid to tractor to proper level. Continue repeating this until pump meets the 2,900 psi max level and the tractor's hydraulic fluid level no longer needs additional fluid.

To operate the Bale Band-It one should pull out on the E-Stop button and turn the manual ball valve on the accumulator manifold to “Live Power On”. Apply hydraulics at the tractor and begin baling to cycle the Bale Band-It. The accumulators(s) and accumulator circuit will then automatically adjust with the variable flow requirements of the load (Bale Band-It) and the relatively constant flow rate of the tractor, all without operator interaction.

During normal operation if operator needs to manipulate the machine or clear out a busted bale or similar situation that requires person to put themselves in “harms way”, then the Bale Band-It's live power should be shut down. First, turn off hydraulic power at the tractor. Then press the E-Stop button and turn the manual bail valve on the accumulator manifold to “Cycle Stop”. Bale Band-It is then safe to approach and perform simple in the field operational adjustments.

When the Bale Band-It or any component of its hydraulic system are serviced, additional precautions must be taken. First, turn off hydraulic power at the tractor. Put the tractor remote in the float position, relieving all pressure off the pressure line. Then press the E-Stop button and turn the manual ball valve on the accumulator manifold to “Cycle Stop”. Then turn the manual ball valves at the end of each accumulator to the closed position. The manifolds and hoses on the Bale Band-It are then safe to service. If service must be completed on the accumulator(s) then the nitrogen gas bladder must be safely discharged.

### Description of Trial Run

In a reduction to practice, a trial run consisted of properly sized accumulator(s) connected to accumulator circuit. Bale Band-It model 200,and the John Deere 5085E tractor with a low flow fixed displacement pump (20) rated at sixteen gpm.

Without the accumulator and circuit, this tractor would not be able to operate the Bale Band-It. This tractor does not meet two of the Bale Band-It's major hydraulic requirements. First, the Bale Band-It requires a closed center system (variable displacement piston pump). Typically an open center system (fixed displacement pump) would overheat and damage the fixed displacement pump when the Bale Band-It doesn't require the full oil output that the fixed displacement pump was pumping. Note the hydraulic demand from the Bale Band-It is variable, at times requiring flows in excess of forty gpm at max operation to zero gpm when waiting on a bale from the baler. Secondly, the Bale Band-It requires a minimum hydraulic flow rate of twenty gpm with a recommended flow rate of at least twenty-five gpm. Flows less than twenty gpm will cause machine failure due to inadequate flow and extreme pressure reductions leading to stalls.

The tractor's hydraulic pressure was set to a max 2,950 psi when tractor was running at 540 pto rpm. In the accumulator circuit 1 the pressure switch's 7 upper switch point was set to 2,900 psi while the lower switch point was set to 2,875 psi (or 25 psi hysteresis). When the pressure switch 7 read 2,900 psi, it turned its electrical output off, switching power off to a normally open blocking valve 4, which allowed the oil flow from the tractor to be diverted to the return line at low pressure. When the pressure switch 7 read 2,875 psi or less, its electrical output energized, switching power on to a normally open blocking valve 4, which closes the path to the return line and causes the tractor flow to be diverted back to charging the system. Test equipment was situated to read and record pressures, flow rates, and circuit cycle times. A Bale Band-It model 200 machine was used as the implement demand load 3 on the hydraulics. The test cycled forty-two small square bales through the Bale Band-It at the maximum machine rate.

TEST RESULTS: The tractor's maximum hydraulic flow rate measured 15.3 gpm. During operation the system pressure on the Bale Band-It was maintained within an acceptable range from 2,660-2,250 psi but was generally maintained around 2,500 psi. System pressure being maintained in this acceptable range is an indicator that the accumulators and circuit are properly sized and adjusted with the load (Bale Band-It's hydraulic requirements). Because the Bale Band-It's hydraulic requirements were met, all functions on the Bale Baud-It performed without failure. Tank pressure briefly peaked out at 400 psi but was generally maintained around 30 psi. Overall cycle time for the forty-two bales was 3 minutes and 54 seconds. This translates to 5.57 seconds per bale, which is within 1.3% of the 5.5 seconds per bale that the Bale Band-It was previously recognized to process using a much superior, larger John Deere 6430 Premium tractor with a high flow variable displacement pump (19) rated at 29 gpm. On the Bale Band-It, eight different hydraulic cylinder and two different motor functions had their cycle times recorded throughout the forty-two bale process.

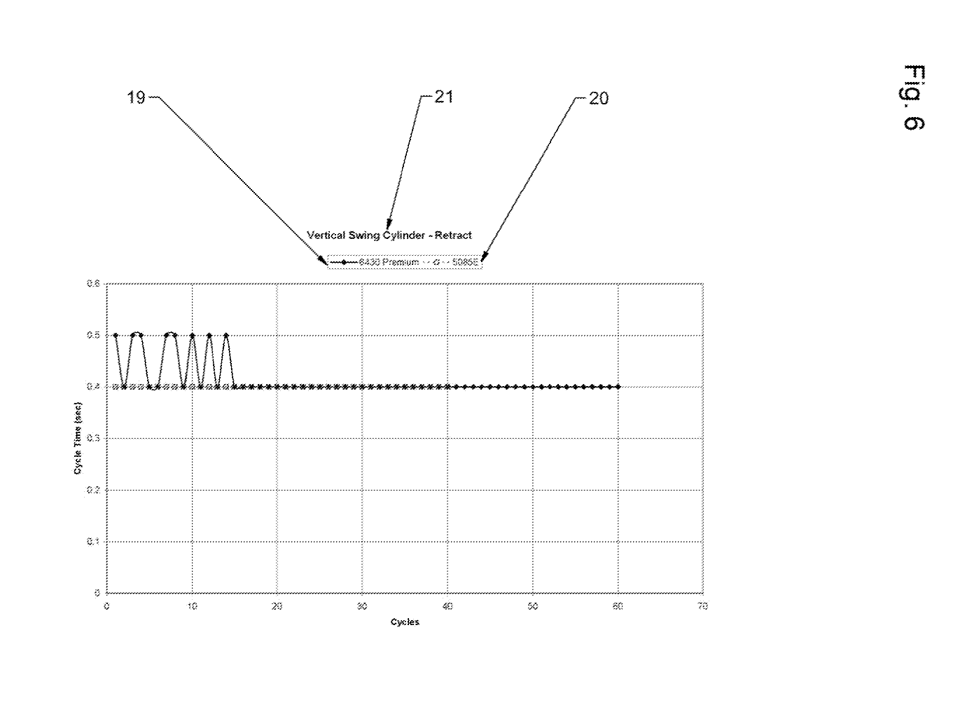

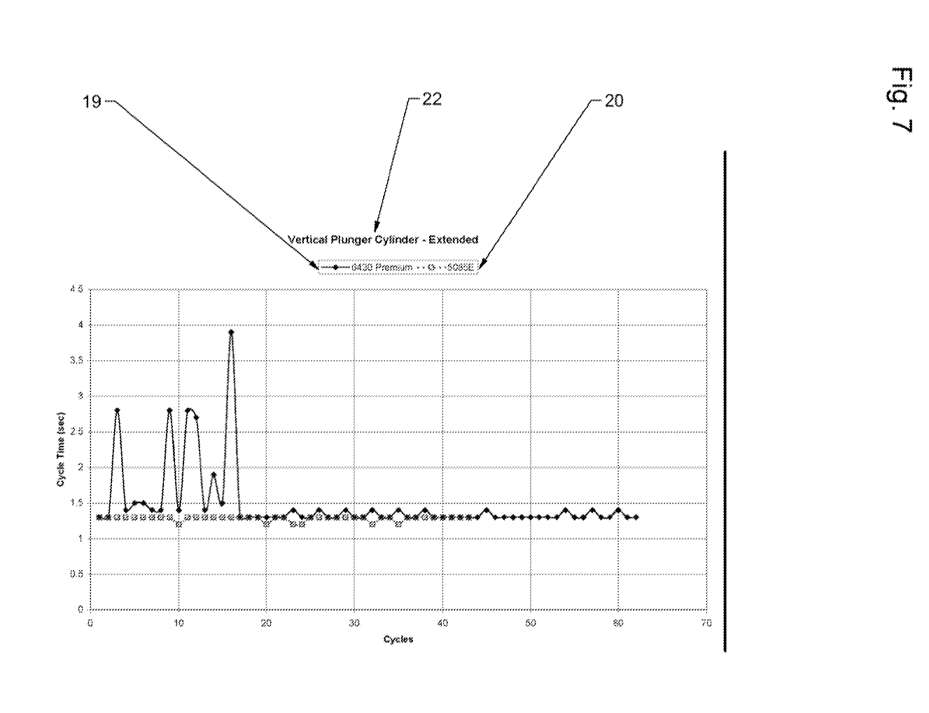

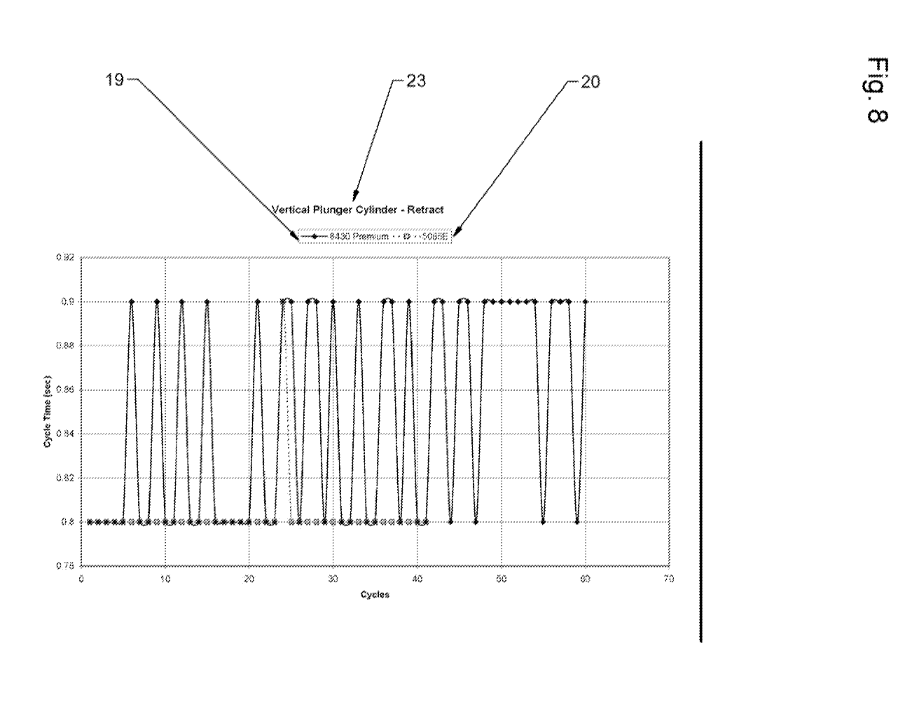

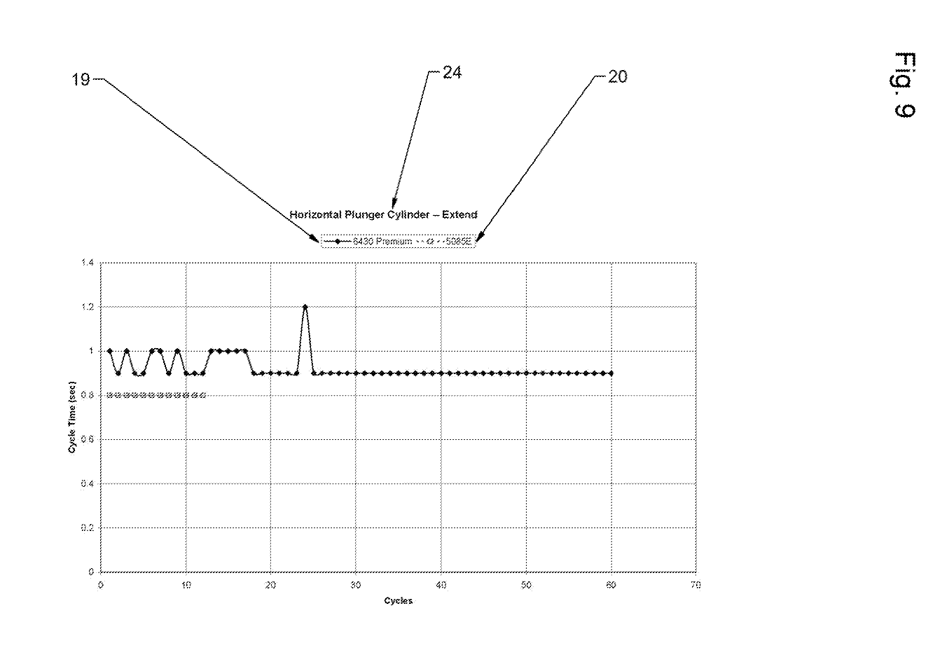

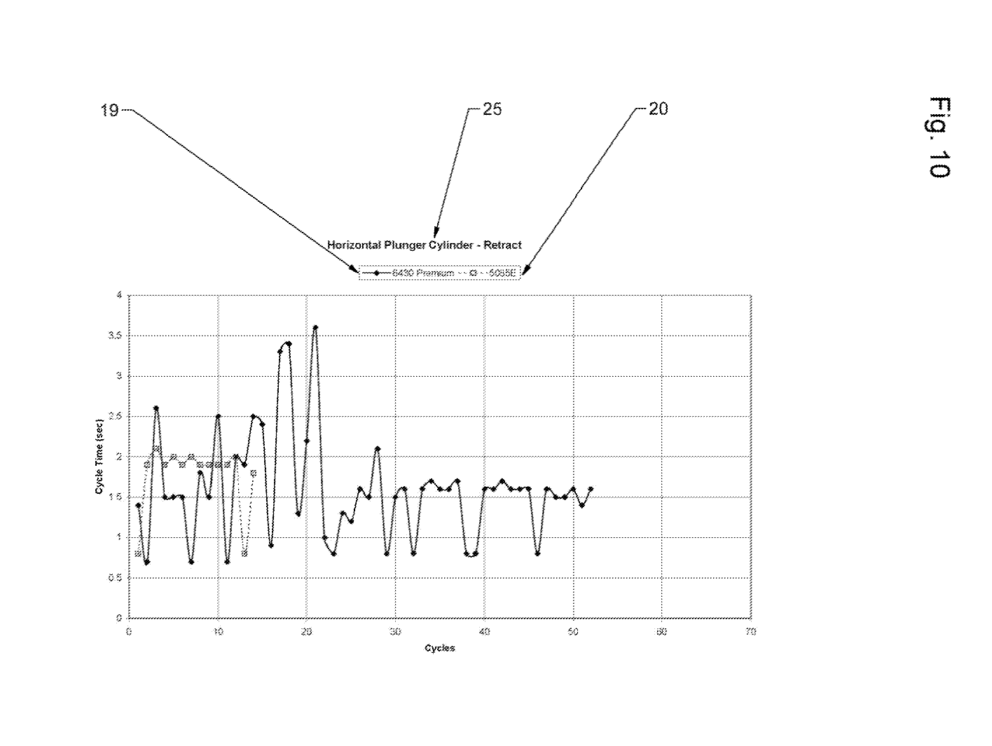

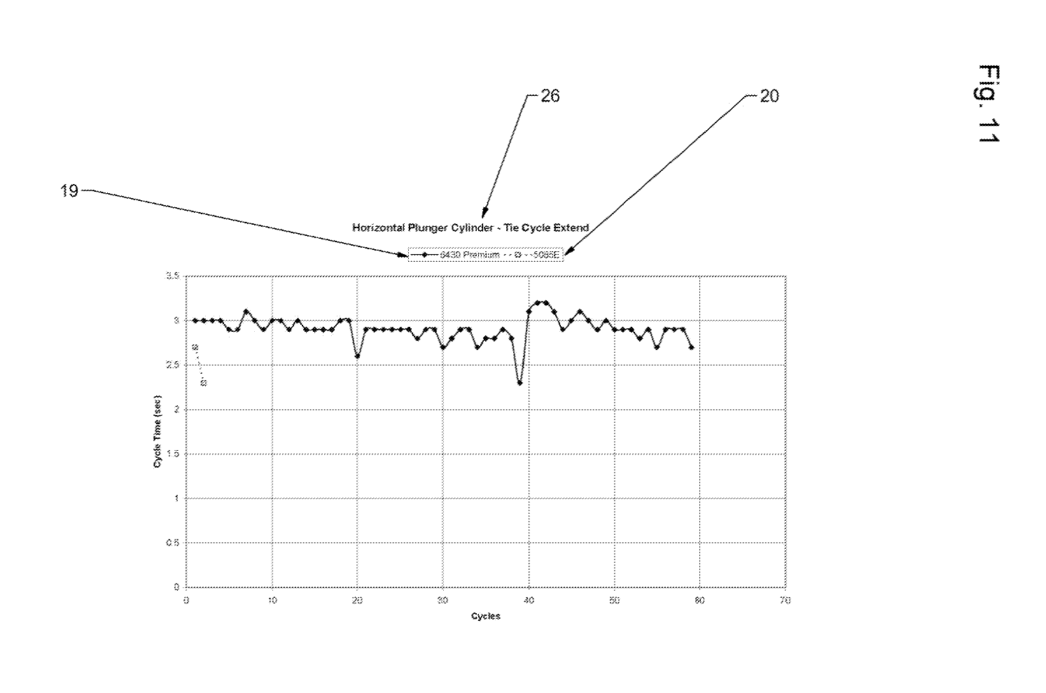

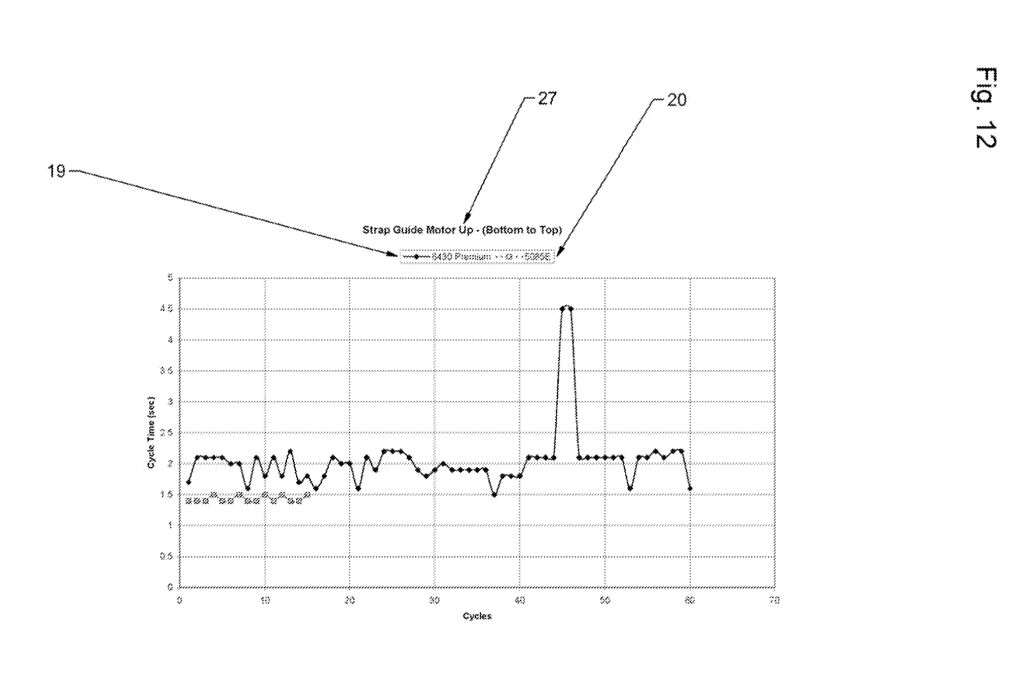

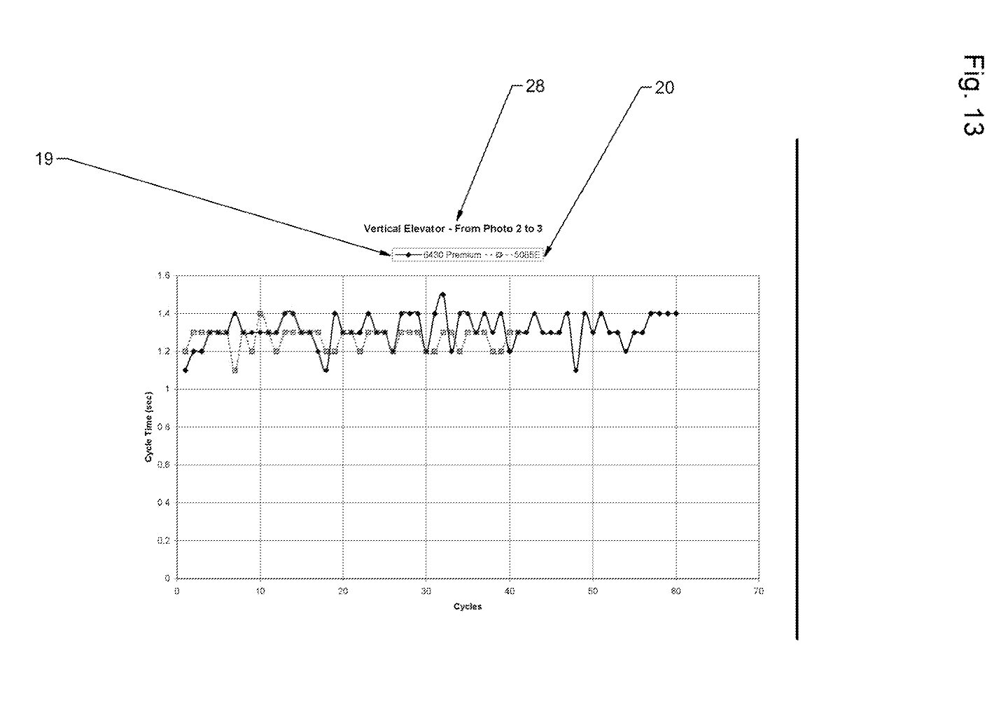

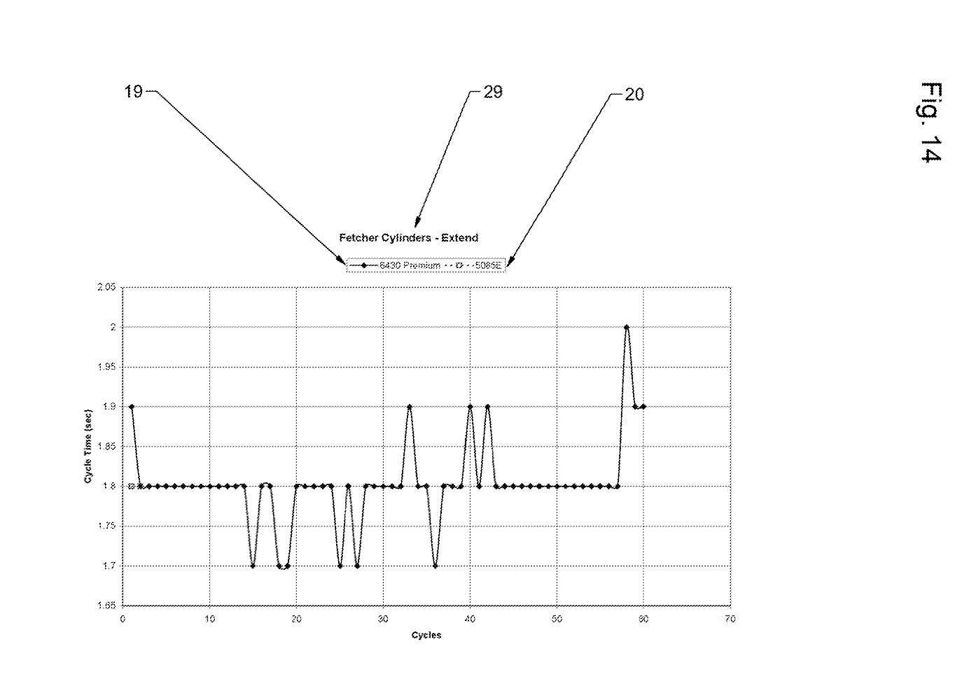

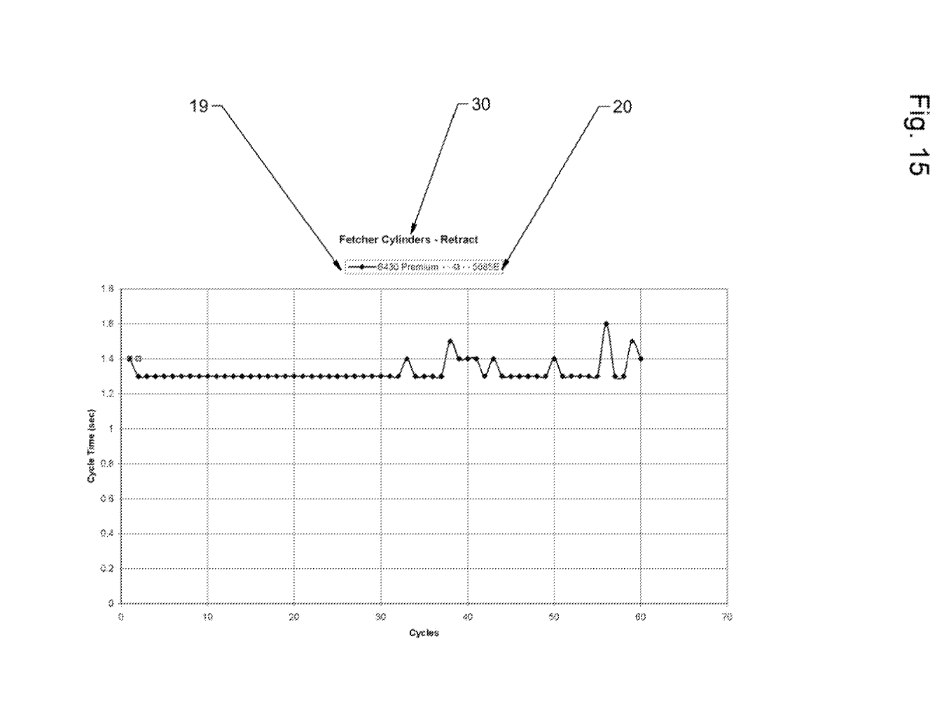

These ten different cylinder and motor function results are shown in FIGS. 6-15. These figures compare cycle times using the John Deere 5085E tractor with a low flow fixed displacement pump (20) with the John Deere 6430 Premium tractor with a high flow variable displacement pump (19). The vertical swing cylinder's retract 21 cycle time is shown in FIG. 6. The vertical plunger cylinder's extend (22) cycle time is shown in FIG. 7. The vertical plunger cylinder's retract 23 cycle time is shown in FIG. 8. The horizontal plunger cylinder's extend 24 cycle time is shown in FIG. 9. The horizontal plunger cylinder's retract 25 cycle time is shown in FIG. 10. The horizontal plunger cylinder's tie cycle extend 26 cycle time is shown in. FIG. 11. The strap guide motor up 27 cycle time is shown in FIG. 12. The vertical elevator motor moving bale from photocell two to photocell three 28 cycle time is shown in FIG. 13. The fetcher cylinder's extend 29 cycle time is shown in FIG. 14. The fetcher cylinder's retract 30 cycle time is shown in FIG. 15.

When comparing these cycle times with the cycle times on the superior, more expensive, larger high flow closed center tractor: the accumulator setup had equal performance on five of the functions, it was faster on four of the functions, and was slightly slower on one of the measured functions. Hydraulic oil temperatures were in safe range below 180° F.

Alternative Embodiments: A variation of said invention would be to allow computer output of implement to also turn on blocking valve 4 causing path to be blocked and fixed displacement pump 2 to send oil to load sooner than pressure switch 7 normally would. This may be advantageous if there is a known time in the cycle that additional oil will be required.

A further embodiment of said invention would be to include a computer output signal from various sensors and microprocessors of implement to completely control blocking valve 4 causing path to be blocked or open depending upon the status of the computer. This may be advantageous when implement processors could accurately predict hydraulic flow requirements.

While the disclosure mentions use on a towed implement such as a baler or a bale bundler, stacker or accumulator like the Bale Band-It, other embodiments would include using this invention on any towed or pushed item (such as a front end loader), such as a tractor trailer rig, cutters, chemical applicators, cranes, mulchers, log splitters, and any mechanical device run in whole or in part using hydraulic or pneumatic pressure, where the mechanical means supplying the pressure is located in a separate vehicle means coupled to said trailer, implement or mechanical device, in another embodiment, the accumulator has a spring or nitrogen loaded bladder inside it, to reduce the amount of fluid required, in another embodiment, multiple smaller accumulators as an alternative to a single larger accumulator are located at one or more locations on the towed or pushed device.

While the invention discloses the use of hydraulic fluid, any of a wide range of fluids or gases could potentially be used and fall within the disclosure. It will be appreciated, however, that the improved implement hydraulic system 1 used to power the implement such as a bale stacking device 17 may also be integral with or otherwise associated with the other systems of the motorized vehicle or tractor without departing from the scope of the present invention.

In another embodiment, the control means for the hydraulic circuit and accumulator valves is controlled either automatically or manually using a portable human-machine interface screen, such as an i-Pad (Reg.™ Apple).

The circuit schematic is not meant to be exhaustive of all possible circuits or valves that would function in similar way but fall within the scope of this invention. Items such as but not limited to the blocking valve 4 could be replaced with a pilot operated valve. Also, circuit shown is a simplified functional circuit and will be significantly different than actual circuit; due to many safety features being required for protection from the accumulator circuit.

The motorized vehicle 14 broadly includes any vehicle that is operable to convey or move the implement vehicle, such as the bale stacking device 17 and that is further operable to provide power for the implement device to operate. In certain embodiments, the motorized vehicle may be any from a wide list of conventional diesel or gasoline-powered utility tractors, trucks, dozers or other drive units for use in the farming or construction industry.

In certain embodiments, the hydraulic pump may include a variable displacement hydraulic pump, such as an axial piston pump, a variable vane pump, or a bent-axis pump, which allows for the displacement of hydraulic fluid to be varied while the hydraulic pump is running. In preferred embodiments, the hydraulic pump may include a constant displacement pump, such as a gear pump, a fixed vane pump, or a screw pump, which allows for the displacement of hydraulic fluid to be held constant while the hydraulic pump is running. Embodiments of the present invention further provide for the hydraulic motors, which may be of similar types as the hydraulic pumps (i.e., axial piston, gear, vane, bent-axis, screw, etc.), to be either variable or constant output, as may be required to implement embodiments of the present invention.

In certain embodiments the hydraulic system 1 may include one or more flexible hoses including connectors for connecting various components of the hydraulic system. In further embodiments, the hydraulic system 30 may include one or a plurality of hydraulic tanks for storing the hydraulic fluid necessary for operation of the hydraulic system. Embodiments of the present invention provide for each of the accumulator 6, and tank, to be integrated with the hydraulic system 1 within the motorized vehicle or at implement vehicle, such as the bale stacking device 17 (i.e., on the towed vehicle), or any combination of the two vehicles. Although the hydraulic system 1, as shown in FIG. 1, illustrates specific placement of components of the hydraulic system 1, it is understood that such an illustration is exemplary, and embodiments of the present invention include additional placements of the components that perform substantially the same function in substantially the same way.

Although this invention has been described with its preferred embodiment(s), it is noted that equivalents may be employed and obvious substitutions made from the components and designs described herein without departing from the scope of the invention.

What is claimed is:

1. An improved implement hydraulic system for powering an implement with a separate motorized vehicle, comprising:
(a) one or more mechanical devices assembled into an implement vehicle array configured with wheels to be a towed or pushed vehicle, wherein the implement vehicle is configured to be towed behind, pulled beside or pushed in front of the separate motorized vehicle, wherein the motorized vehicle and the implement vehicle are configured to operate in a field at a linear speed between zero and twenty miles per hour;
(b) a hydraulic circuit in whole or in part on the implement vehicle coupled to the implement mechanical devices, said circuit comprising one or more components each from a list including:
a. a check valve,
b. a pressure switch engaged with the hydraulic circuit,
c. a block valve,
d. a hydraulic accumulator, wherein the reserve hydraulic power in said accumulators is operable to power the mechanical components of the towed vehicle; and
e. one or more hydraulic transfer lines connecting
i. the motorized vehicle pump and,
ii. Said implement vehicle hydraulic circuit.

2. The improved implement hydraulic system of claim 1, wherein the system is further operable to power auxiliary components of the towed implement, including one or more of a group of components including any of the following:
(a) a conveyor drive,
(b) a lift cylinder,
(c) a compressive ram,
(d) a rake arm,
(e) a transfer ram,
(f) a strapping head and/or
(g) a discharge gate.

3. The improved implement hydraulic system of claim 1, wherein the implement is
(a) a baler,
(b) a bale stacking device and/or
(c) one or more mechanical devices required hydraulic or pneumatic pressure to operate.

4. The improved implement hydraulic system of claim 1, wherein the hydraulic pump is attached to the towed implement hydraulic system by flexible hose means.

5. The improved implement hydraulic system of claim 1, wherein the hydraulic pump is selected from either
(a) a variable displacement or
(b) a fixed displacement output.

6. The improved implement hydraulic system of claim 1, wherein any one or more of the accumulator or other hydraulic circuit components are mounted on the motorized vehicle.

7. The improved bale processing or stacking device system of claim 3, wherein the motorized vehicle hydraulic pump is selected from
(a) a variable displacement pump or
(b) a fixed displacement pump.

8. The improved bale stacking device system of claim 3, wherein the one or more power transfer lines are quick disconnect hydraulic hoses.

9. An improved towed bale processing or bale stacking hydraulic system for powering a bale processing or stacking device with a motorized tow vehicle, comprising:
(a) one or more mechanical bale processing or stacking devices assembled into an array configured with two or more wheels to be a towed vehicle, wherein the towed vehicle is configured to be towed behind a motorized tow vehicle, wherein the tow vehicle and the towed vehicle are configured to operate in a field at a speed between zero and twenty miles per hour;
(b) a hydraulic circuit on the towed vehicle coupled to the mechanical devices, said circuit comprising one or more components each from a list including:
a. check valves,
b. pressure switches engaged with the hydraulic circuit.,
c. block valves
d. hydraulic accumulators, wherein the reserve hydraulic power in said accumulators is operable to power the mechanical components of the bale processing or bale stacking device; and
e. one or more hydraulic transfer lines connecting
i. the tow vehicle pump,
ii. hydraulic accumulator,
iii. check valves
iv. block valves and
v. the towed vehicle mechanical devices.

10. The improved bale processing and bale stacking device hydraulic systems of claim 9, wherein the hydraulic circuit and pump is further operable to power auxiliary components of the bale processing and stacking devices, including one or more of a group of components including any of the following:
(a) a bale feed conveyor drive,
(b) a lift cylinder,
(c) a compressive ram,
(d) a transfer ram,
(e) a strapping head and/or
(f) a discharge gate.

11. The improved bale processing and bale stacking device hydraulic systems of claim 9, wherein the hydraulic pump is selected from
(a) a variable displacement pump or
(b) a fixed displacement pump.

12. An improved hydraulic system for powering a mobile bale stacking device with a tractor, comprising:
(a) one or more mechanical bale stacking devices assembled into an array, said array configured with two or more wheels to be a towed vehicle, wherein the towed vehicle is configured to be towed behind the tractor, wherein the tractor and the towed vehicle are configured to operate in a field at a speed between zero and twenty miles per hour;
(b) a hydraulic circuit on the towed vehicle coupled to the bale stacking mechanical devices, said circuit comprising one or more components each from a list including:
a. check valves,
b. pressure switches engaged with the hydraulic circuit,
c. block valves,
d. hydraulic accumulators within said circuit, wherein the reserve hydraulic power in said accumulators is operable to power the variable hydraulic demands of the mechanical components of the bale stacking device without the substantial buildup of deleterious heat; and
e. one or more flexible hydraulic transfer lines connecting
i. the tractor pump and,
ii. towed vehicle hydraulic circuit.

13. The improved bale stacking device hydraulic system of claim 12, wherein the hydraulic circuit includes a control system for controlling one or more of the following:
(a) a speed of the pump,
(b) a torque of the mechanical devices, and a direction of the mechanical devices.

14. The improved bale stacking device hydraulic system of claim 12, wherein the hydraulic circuit includes a control system for controlling an output of the hydraulic circuit components and the bale stacking mechanical components.

15. The accumulator of claim of claim 12 which further includes an internal nitrogen pressurized bladder.

16. The control system of claim 14 which further includes a touch-screen human machine interface providing instantaneous control and system status.
